(19) United States
(12) Patent Application Publication
(10) Pub. No.: US 2013/0044332 A1
(43) Pub. Date: Feb. 21, 2013

(54) SURFACE PROFILE MEASUREMENT APPARATUS AND ALIGNMENT METHOD THEREOF AND AN IMPROVED SUB-APERTURE MEASUREMENT DATA ACQUISITION METHOD

(71) Applicant: Chao-Wen LIANG, Taichung City (TW)

(72) Inventor: Chao-Wen LIANG, Taichung City (TW)

(21) Appl. No.: 13/589,612

(22) Filed: Aug. 20, 2012

Related U.S. Application Data
(60) Provisional application No. 61/525,743, filed on Aug. 20, 2011.

(51) Int. Cl. G01B 11/24; G06F 19/00; G06F 15/00; G01B 11/02; G01B 11/26

(52) U.S. Cl. 356/512; 356/601; 356/152.1; 702/150; 702/94

(57) ABSTRACT

A surface profile measurement apparatus, which measures a surface profile of an object, includes a wavefront measurement unit, a driving unit and a rotation unit. The wavefront measurement unit has an image sensor and emits a detecting light. The driving unit has a plurality of stages for moving the object or the wavefront measurement unit. The rotation unit has a rotation axis, is disposed on one of the stages of the driving unit, and holds the object. When measuring the object, the rotation unit rotates the object and the image sensor simultaneously exposes and acquires a measurement data, formed by the detecting light reflected from the object. An alignment method of the surface profile measurement apparatus and an improved sub-aperture measurement data acquisition method are also disclosed.

### CROSS REFERENCE TO RELATED APPLICATIONS

The non-provisional patent application claims priority to U.S. provisional patent application with Ser. No. 61/525,743 filed on Aug. 20, 2011. This and all other extrinsic materials discussed herein are incorporated by reference in their entirety.

### BACKGROUND OF THE INVENTION

1. Field of Invention

The invention relates to a surface profile measurement apparatus and an alignment method thereof, and an improved sub-aperture measurement data acquisition method.

2. Related Art

With the increasing demands of the industry, optical devices have been made more and more complicated and complex. An inseparable relationship has been established between an optical device and the information industry, the communication industry, the automatic control industry, the medical industry, the aerospace, or even the daily life and the like. Inside these optical devices, the optical lens is usually one of the most important components. The accurate measurement of such the optical lens to ensure the lens meet the design specification is greatly demanded.

The non-contact interferometric measurement optical technique has been widely applied to the measurement of the surface profile of the precision optical lens. When the interferometry measurement of the surface profile is proceeded, a tested wavefront reflected by a tested surface and a reference wavefront reflected by a reference surface are combined to generate the optical interferogram. An interferometer measures the interference phase of the optical interferogram and the optical interference phase is then converted to the surface deformation error. A spatial variation in an intensity profile of the optical interferogram is an optical interference phase difference between the test beam wavefront phase and the reference beam wavefront phase. This phase difference is induced from a profile variation of a shape of the tested surface correlate and the reference surface. The phase shifting interferometry (PSI) is an interference phase measurement method, which is relied upon, wherein a known phase shift amount is introduced into the multiple interferograms at different times, so that the interferograms are modulated at the predetermined phase interval. Then, the interference phase of the measurement position is calculated according to the light intensity of the interferogram through the calculation of the phase shifting formula, so that the interference phase of each interferogram can be precisely determined. However, the phase shifting measurement process needs the stable environment without random mechanical vibrations or turbulence so that the ideal measurement result can be obtained.

The interferometer with a sub-aperture measurement method may be used to measure an aspheric or high numerical aperture lens. When this measurement method is implemented, the lens or interferometer has to be re-positioned so that the interferometer can measure the sub-aperture profile data at different positions on the lens and stitch the sub-aperture surface profile data into a complete lens surface profile. The conventional sub-aperture measurement technique needs to perform the phase shift measurement on the sub-apertures at different positions of the object so as to obtain the complete object sub-aperture interference phases for the stitching of the complete global interference phase data. In addition, in order to increase the measurement accuracy and reduce the stitching error, the acquired neighboring sub-aperture data need to have the sufficient overlapped area. Thus, the number of the sub-apertures at different positions of the tested surface is increased, and the required measuring time is lengthened.

In addition, when the interferometer performs the sub-aperture stitching measurement, the phase data of the lens at different sub-aperture positions need to be measured. Thus, the interferometer or the lens needs to be moved so that the detecting light incidents at different lens positions. However, because the problem of random mechanical vibrations inevitably occurs while the stage is moving or decelerating, the phase shifting measurement cannot be implemented until the random mechanical vibrations generated from moving or decelerating stage disappear. Therefore, the overall measurement speed is literally restricted by the time of the phase shift measurement, the motion and the speed of the moving stage at each sub-aperture position, and the rigidity of the motion stage. Of course, using the high rigidity motion stage can also shorten the time of completely stopping of the mechanical vibrations from the stages, but also increase the cost of the measurement device.

Due to the problem of the random mechanical vibrations of the motion stage, the conventional sub-aperture measurement method cannot obtain a considerable number of sub-aperture interference phases in a short period of time, and the optimum selection must be traded off in between the high measurement precision and the long measurement time.

### SUMMARY OF THE INVENTION

In view of the foregoing, an object of the invention is to provide a surface profile measurement apparatus and an alignment method thereof and an improved sub-aperture measurement data acquisition method capable of continuously measuring different portions of an object and simultaneously exposing and acquiring a plurality of interferograms, wherein a complete surface profile of the object is acquired in a short period of time, thereby sufficiently decreasing the measuring time.

To achieve the above objective, the present invention discloses a surface profile measurement apparatus, which measures a surface profile of an object. The surface profile measurement apparatus includes a wavefront measurement unit, a driving unit, and a rotation unit. The wavefront measurement unit has an image sensor and emits a detecting light. The driving unit has a plurality of stages for moving the object or the wavefront measurement unit. The rotation unit has a rotary axis and is disposed on one of the stages of the driving unit. The rotation unit holds the object. When measuring the object, the rotation unit rotates the object and the image sensor simultaneously exposes and acquires a measurement data, which is formed by the detecting light reflected from the object.

In one embodiment, the stages have a defocusing motion, a decentering motion and a tilting motion for proceeding a surface curvature fitting process of the wavefront of the detecting light and the surface of the object.

In one embodiment, the stages providing the tilting motion have a rotation axis, and the rotation axis is substantially parallel to the gravity direction.

In one embodiment, the object has a symmetrical axis, the wavefront measurement unit has an optical axis, and when measuring the object, the rotary axis is substantially collinear with the symmetrical axis and is substantially coplanar with the optical axis.

In one embodiment, the measurement apparatus further comprises a rotational position measurement device, which is electrically connected to the wavefront measurement unit and for obtaining a rotational angle of the rotary axis. When the wavefront measurement unit captures the measurement data, the wavefront measurement unit records the rotational angle of the rotary axis and correlates with the measurement data.

In one embodiment, the wavefront measurement unit is an interferometer, and when the rotation unit rotates the object for two or more rounds, the wavefront measurement unit acquires the plural measurement data with different interference phase changes of the same measured point and the same measured area of the object.

In one embodiment, the plural measurement data with the different interference phase changes are induced from random mechanical vibrations generated from the motions of the wavefront measurement unit, the driving unit or the rotation unit.

In one embodiment, the measurement apparatus further comprises an interference phase shifter, which is coupled to the rotation unit, the driving unit or the wavefront measurement unit. When the object rotates, the interference phase shifter simultaneously phase shifts the plural measurement data with random or predictable interference phase changing.

To achieve the above objective, the present invention also discloses an alignment method of a surface profile measurement apparatus, which is implemented with a surface profile measurement apparatus for measuring a surface profile of an object. The surface profile measurement apparatus comprises a wavefront measurement unit, a driving unit, a rotation unit and an object alignment unit. The rotation unit has a rotary axis, the object has a symmetric axis, and the wavefront measurement unit has an optical axis. The alignment method comprising: disposing the object on the rotation unit; the wavefront measurement unit emitting a detecting light, which proceeds a surface curvature fitting on a measured area of the object surface; the rotation unit rotating the object to at least two different rotational angles and acquiring corresponding measurement data at the different rotational angles; calculating an alignment error according to the measurement data acquired at different rotational angles; and adjusting the object alignment unit according to the alignment error, whereby the rotary axis and the object axis are substantially collinear.

In one embodiment, the object alignment unit has a multi-axis alignment adjustment platform for moving the object in two translational or two angular directions.

In one embodiment, the alignment error is derived by a lens prescription of the object or travels of motions of the driving unit.

In one embodiment, the alignment error comprises an angular or translational alignment error between the rotary axis of the rotation unit and the symmetric axis of the object.

In one embodiment, the alignment error comprises an angular or translational alignment error between the rotary axis of the rotation unit and the optical axis of the wavefront measurement unit.

To achieve the above objective, the present invention also discloses an improved sub-aperture measurement data acquisition method, which is implemented with a surface profile measurement apparatus comprising a driving unit, a rotation unit and a wavefront measurement unit. The data acquisition method comprising: moving the driving unit and a measuring light emitted by the wavefront measurement unit proceeding multiple surface curvature fittings to the same measured area of an object, wherein one of the curvature fittings is along a first direction of the object; rotating the rotation unit and the wavefront measurement unit acquiring a plurality of first measurement data and a plurality of secondary measurement data, wherein the captured first measurement data have an elongated axis direction corresponding to the first direction of the object; and correlating the first measurement data and the secondary measurement data with the coordinates of the object, wherein a part of the first measurement data and a part of the secondary measurement data are overlapped at the same coordinate position.

In one embodiment, the data acquisition method further comprises: adding a calibration data of the wavefront measurement unit to calibrate a wavefront error or a coordinate error induced from the wavefront measurement unit; and correlating the calibrated first measurement data and the secondary measurement data to the coordinates of the object.

In one embodiment, the elongated axis direction of the first measurement data correspondingly is the tangential direction of the object, and the object is rotated so as to measure tangential direction surfaces of different areas of the object.

In one embodiment, when the wavefront measurement unit obtains the first measurement data in a tangential direction of the object, the radius of curvature of the incident measuring light wavefront upon the measured area substantially equals the optimum fitted radius of curvature along the tangential direction of the measured area.

In one embodiment, the secondary measurement data has another elongated axis direction, which corresponds to a second direction of the object, and the first direction and the second direction are different.

In one embodiment, when the wavefront measurement unit obtains the secondary measurement data with elongated axis in a sagittal direction of the object, the radius of curvature of the incident measuring light wavefront upon the measured area substantially equals the optimum fitted radius of curvature along the sagittal direction of the measured area.

In summary, the surface profile measurement apparatus, the alignment method thereof and the improved sub-aperture measurement data acquisition method of the invention have the feature that they can continuously measure the object and expose and simultaneously acquire a plurality of measurement patterns, so that the time for the measurement can be shortened.

### BRIEF DESCRIPTION OF THE DRAWINGS

The invention will become more fully understood from the detailed description and accompanying drawings, which are given for illustration only, and thus are not limited to the present invention, and wherein:

FIGS. 1A and 1B are schematic illustrations showing a surface profile measurement apparatus according to a first embodiment of the invention, wherein FIG. 1B is a brief schematic illustration of FIG. 1A;

FIG. 2A is a schematic side view showing the detecting light incident to the object surface;

FIG. 2B is a schematic top view showing the detecting light of FIG. 2A incident to the object surface;

FIG. 3 is a flow chart showing an alignment method of a surface profile measurement apparatus of the invention;

FIG. 4 is a schematic illustration showing the second preferred embodiment of the invention of the surface profile measurement apparatus;

FIG. 5 is a schematic illustration showing a third preferred embodiment of the invention of the surface profile measurement apparatus;

FIG. 6 is a schematic illustration showing fourth preferred embodiment of the invention of the surface profile measurement apparatus;

FIG. 7 is a flow chart showing an improved sub-aperture measurement data acquisition method of the invention;

FIG. 8 is a schematic top view showing an object, wherein the acquired measured data with an enlonged data axis in two directions; and

FIGS. 9A and 9B are interferograms when an aspheric surface is measured in the tangential direction and the sagittal direction, respectively.

### DETAILED DESCRIPTION OF THE INVENTION

The present invention will be apparent from the following detailed description, which proceeds with reference to the accompanying drawings, wherein the same references relate to the same elements.

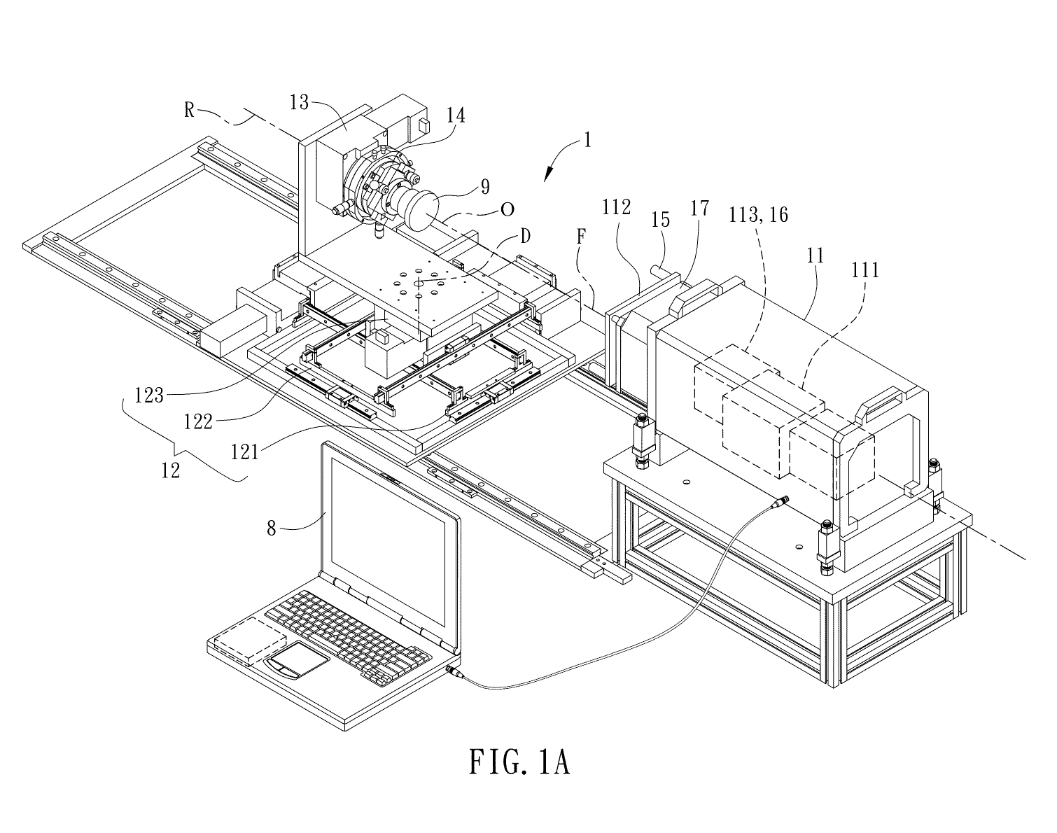

FIG. 1A is a schematic illustration showing a surface profile measurement apparatus according to a first embodiment of the invention, and FIG. 1B is a brief schematic illustration of FIG. 1A. Referring to FIGS. 1A and 1B, a surface profile measurement apparatus 1 measures a surface profile of an object 9. Any object 9 can be measured as long as it has a specular surface, such as a spherical lens or an aspheric lens, or a lens mold, with a symmetrical axis. In this embodiment, the object 9 is an aspheric lens and has a symmetric axis O. The surface profile measurement apparatus 1 includes a wavefront measurement unit 11, a driving unit 12 and a rotation unit 13.

The wavefront measurement unit 11 has a light source 111, an optical axis F and an image sensor 113. In this embodiment, the light source 111 is a laser light source, and emits a detecting light symmetrical to the optical axis F to the object 9 and reflects a portion of the detecting light back to the wavefront measurement unit 11, and the image sensor 113 exposes and simultaneously acquires at least one measurement data. The light source 111 is a component of the wavefront measurement unit 11 but is not necessarily to be disposed within the housing of the wavefront measurement unit 11.

It is to be noted that the wavefront measurement unit 11 may be a wavefront measurement device such as a Shack-Hartman wavefront sensor or a Ronchi tester that is not based on the interferometric principle; or a wavefront measurement device such as a Fizeau interferometer based on the interference principle. In this embodiment, the wavefront measurement unit 11 is a Fizeau interferometer, but the invention is not restricted to the wavefront measurement device based on the interference principle.

Upon measurement, the detecting light is reflected by the surface of the object 9 and returns to the wavefront measurement unit 11 to proceed the measurement. The wavefront measurement unit 11 has a measurement dynamic range within which the interferometer is capable of measuring the wavefront phase difference or wavefront slope error accurately. In order to ensure that the measured wavefront of the detecting light falls within the measurement dynamic range of the wavefront measurement unit 11, the maximum wavefront slope error or the maximum wavefront phase difference of the detecting light has to be minimized upon measurement. For the interferometer measurement, the interference fringe density of the detected interferogram has to be as coarse as possible to be within the measurement dynamic range of the interferometer. If the detecting beam is normal incident upon the tested object, the wavefront slope of the returning detecting beam is then minimized.

In the sub-aperture measurement method, the radius of curvature of the wavefront of the detecting light has to be equal to or near the radii of curvature of the surfaces of all the measured points in the measured area within the measured sub-aperture of the object 9, and the centers of curvature of both of them are coincident at the same point. If the object 9 is a spherical lens, because all its surface measured points have a fixed curvature and the centers of curvature of all the surface measured point are located at the same point, the incident detecting lights at all the measured points in the sub-aperture are perpendicularly reflected back to the wave front measurement unit 11, and the coarse density interference fringes are obtained to proceed the measurement. However, because the radii of curvature of all the surface measured points of the aspheric lens are not constant and the centers of curvature of all the surface measured points are not at the same point, the locations of the centers of curvature of all the surface measured points may be an assembly of a line or a space volume. Therefore, when the aspheric lens is measured, the optimum center of curvature and optimum radius of curvature of the detecting light in a sub-aperture are needed to be determined to minimize the returning wavefront slope error. That is, the radii of curvature and the centers of curvature of all the measurement points in the sub-aperture do not significantly differ from the corresponding radius of curvature and center of curvature of the detecting light, wherein the significant differences will cause the significant interference phase difference of the reflected detecting wavefront, cause the over dense interference fringes to exceed the dynamic measurement range of the wavefront measurement unit 11, and thus reduce the measurement precision. In another method, it is possible to selectively select the measured area within the sub-aperture, such as an annular region or a longitudinal region, so that the radius of curvature and the center of curvature of the wavefront of the detecting light can approach or equal the radius of curvature and the center of curvature of the correspondingly selected measured area. The process of implement of the optimum radius of curvature and optimum center of curvature of the wavefront of the detecting light to minimize the wavefront phase difference or the wavefront slope error of the detecting light reflected from the measured surface of the object 9 is referred as the surface curvature fitting.

In order to implement the surface curvature fitting, the object 9 or the wavefront measurement unit 11 has to be moved such that the radius of curvature and the center of curvature of the wavefront of the detecting light incident at the measured point of the object 9 is near the radius of curvature and correspondingly the center of curvature of the object 9. In the surface curvature fitting process, the wavefront phase difference in the measured area in the sub-aperture has to be within the dynamic measurement range of the wavefront measurement unit 11. A best fitted radius of curvature and a best fitted center of curvature are present in this dynamic measurement range so that the density of the interference fringes in the measured area is minimized. However, when an upper bound and a lower-bound of the dynamic measurement range of the wavefront measurement unit 11 are given, the best fitted center of curvature are not fixed to a position point neither the best fitted radius of curvature fixed to a value. Instead, best fitted center of curvature and the best fitted radius of curvature of the fitted measured surfaces will have certain space and range respectively so that the wavefront phase difference or wavefront slope error of the detecting light is within the dynamic measurement range of the wavefront measurement unit 11.

In the invention, the driving unit 12 has a plurality of stages to move the object 9 or the wavefront measurement unit 11 to proceed a decentering motion, a tilting motion and a defocusing motion of the object 9 to implement the surface curvature fitting process. In the example of FIG. 1B, the driving unit 12 is coupled to the rotation unit 13, which holds the object 9 to rotate object 9. The decentering motion is to move the object 9 laterally with respect to the optical axis F of the detecting light so that the center of curvature of the detecting light is at the best fitted center of curvature. The tilting motion is to change the angle between the detecting light optical axis F and the symmetric axis O so that the detecting light can detect the surfaces of different radial positions of the object 9. The defocusing motion is to move object 9 axially respect to the optical axis F of the detecting light so that the radius of curvature of the detecting light incident is the best fitted radius of curvature. The methods of proceeding the defocusing motion, the decentering motion and the tilting motion will be described in the following.

In this embodiment, the rotation unit 13 is disposed on a tilting stage 123, the rotation unit 13 has a rotation axis R, and the object 9 is held by the rotation unit 13. In this embodiment, the rotation unit 13 has a vacuum lens holder for holding the object 9. In practice, the vacuum lens holder may also be replaced with another mechanism, such as a lens clamping jig. Of course, either the vacuum lens holder, the lens clamping jig or another mechanism with the firm holding function can be used, and any mechanism capable of achieving the object of holding the object 9 can be accepted, but the invention is not restricted thereto. The rotation unit 13 rotates the object 9 about the target symmetric axis O so that the image sensor 113 simultaneously exposes and acquires at least one measurement pattern formed by the detecting light reflected from the object 9 at the measured points at different rotational angles.

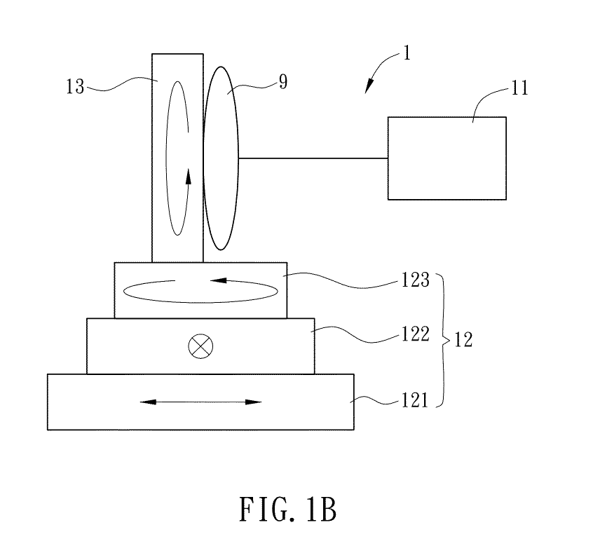

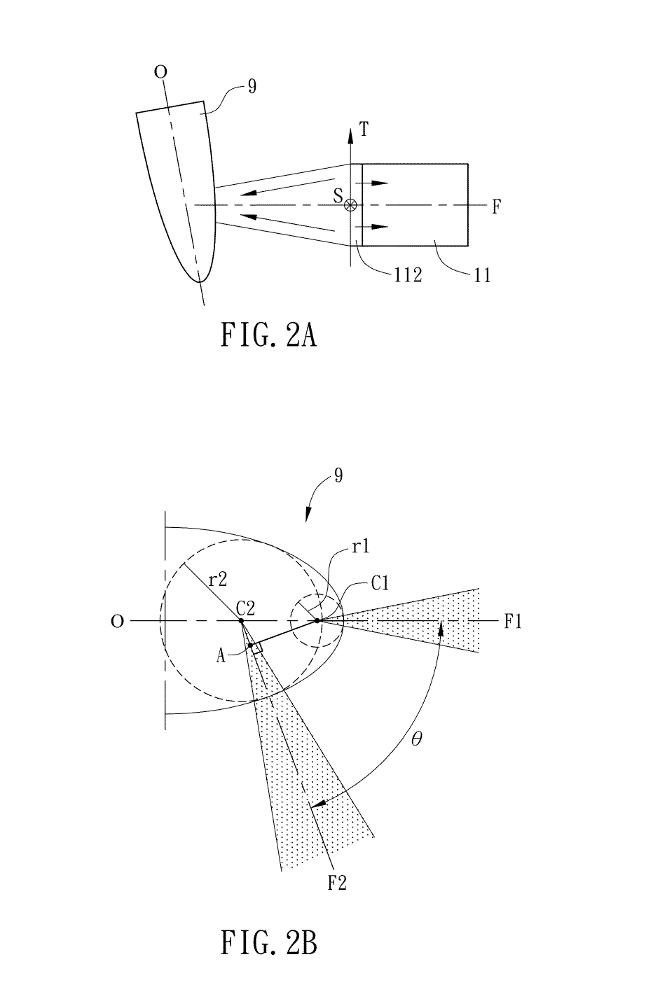

Herein below, the methods of proceeding the defocusing motion, the decentering motion and the tilting motion will be described with reference to FIGS. 2A and 2B simultaneously. FIG. 2A is a schematic illustration showing the detecting light incident to the surface of the object in the tilting motion, wherein only a portion of the object is depicted. FIG. 2A is a partial side view of FIG. 1B. FIG. 2B is a partial schematic top view of FIG. 1B, and is a schematic illustration showing that the detecting light is moved relative to the object 9 in order to proceed the surface curvature fitting and its shown with respect to the fixed object 9. As shown in FIG. 2A, the detecting light emitted from the wavefront measurement unit 11 is incident to the surface of the object 9, and a portion of the detecting light is reflected by the object 9 and combined with a reference wavefront of a reference surface 112 of the wavefront measurement unit 11 to form an interferogram, so that the image sensor in the wavefront measurement unit 11 exposes and acquires a portion of the interferogram as the measurement data. As shown in FIG. 2B, when the detecting light (as indicated by the dotted region) emitted from the wavefront measurement unit 11 is reflected from the measured point of the surface of the object 9, the surface curvature fitting between the wavefront of the detecting light incident to the measured point of the object 9 and the reflecting surface of the object 9 at the measured point has to be performed in order to obtain the measurement data in the sub-aperture. Thus, as shown in FIG. 2B, while the inscribed circle of the object 9 represents the best fitted surface curvature of the surface curvature fitting, the center of the inscribed circle is the best fitted center of curvature and the radius of the inscribed circle is the best fitted radius of curvature. In FIG. 2B, the focal point of the wavefront of the detecting light with the optical axis F2 is C2, and this focal point C2 is the center of the inscribed circle of the surface, wherein C2 falls on the symmetric axis O, and the radius of curvature of the inscribed circle is r2 in this embodiment. However, it is not limited in the invention that the C2 coincident at the symmetric axis O. Given the measurement dynamic range of the wavefront measurement unit 11 and the measured area within the measured sub-aperture, the C2 may not be coincident with the symmetric axis O.

The defocusing motion, the decentering motion and the tilting motion are for most of time applied together. Referring to FIGS. 2A and 2B, the description will be made in the following example, wherein the focus point C1 of the wavefront of the detecting light with the optical axis F2 is moved to the focus point C2 of the wavefront of the detecting light with the optical axis F1. The motion of the focus point of the wavefront from C1 to C2 may be decomposed into the decentering motion of the focus point of the wavefront from C2 to the point A (a transversal displacement perpendicular to the optical axis F2) plus the defocusing motion from the point A to C2 (an axial displacement parallel to the optical axis F2).

When the decentering motion is preceded, the driving unit 12 drives the object 9 or wavefront measurement unit 11 to move in a direction perpendicular to the optical axis F2 of the wavefront measurement unit 11. With a transversal displacement perpendicular to the optical axis F2 of the wavefront measurement unit 11, the center of curvature of the wavefront of the detecting light and the center of the inscribed circle representing the best fitted center of curvature of the measured area of the object 9 are substantially at the same transversal position.

When the defocusing motion is proceeded, the object 9 or wavefront measurement unit 9 is moved in an axial direction parallel to the optical axis F of the wavefront measurement unit 11 and thus the focus point of detecting light is moved from the point A to point C2 as shown in FIG. 2B. Wherein another center of curvature of the inscribed circle with the radius of curvature equal to r2 is coincident with the focus point C2. So, the defocusing motion can change the radius of curvature of the detecting light incident at the surface of object 9, and thus achieve the goal of changing the radius of curvature of the detecting light to be equal to the radius of curvature of the inscribed circle representing the best fitted radius of curvature of the measured area of the object 9.

When the tilting motion is proceeded, the object 9 or the wavefront measurement unit 11 is driven to tilt. That is, changing the angle θ between the symmetric axis O and the optical axis F of the wavefront measurement unit 11 can change the radial position of the detecting light incident at the object 9, and make the optical axis F of the wavefront measurement unit 11 substantially perpendicular to the surface measured area of the object 9. In this embodiment, the movement is from the point C1 (corresponding to the optical axis F1) to the point C2 (corresponding to the optical axis F2), so that the angle between the symmetric axis O and the optical axis F is changed from 0 degree to the angle θ. So, the defocusing motion, the decentering motion and the tilting motion can be implemented with one another, so that the detecting light can measure the measured areas located in different surface positions of the object 9.

It is to be noted that, in practice, one stage can be adopted to proceed one of the defocusing motion, the decentering motion and the tilting motion, and multiple stages can cooperate together to proceed one or more than one of the defocusing motion, the decentering motion and the tilting motion, and the invention does not restricted thereto. Referring again to FIG. 1A, the driving unit 12 in this embodiment has a defocusing stage 121, a decentering stage 122 and a tilting stage 123, which proceed the defocusing motion, the decentering motion and the tilting motion, respectively. In this embodiment, the defocusing stage 121 is moving in the direction toward the wavefront measurement unit 11; the decentering stage 122 is driven in a direction perpendicular to the defocusing motion in the same horizontal plane; the tilting stage 123 is rotated in the horizontal plane with its rotational axis perpendicular to the horizontal plane; and the rotation unit 13 implemented at the top of above-mentioned stages assembly with the rotational axis parallel in the horizontal plane. Thus, the rotational axis of the rotation unit 13 is coplanar with the detecting light optical axis F.

If the rotation unit 13 is placed on the tilting stage 123, then when the measurement data acquisition in rotation is performed at different tilt angles, the magnitude and direction of the torque that loaded at the rotation unit 13 induced from the gravity weight force of the object 9 is preferred to be invariable. As a result, such mechanic design can prevent the rotation unit 13 and its clamping mechanism suffering from minor deformations due to the changing torque, which deteriorate the precision and uncertainty of the measurement. Thus, optimum stage measurement stability is achieved by placing the rotation axis D of the tilting stage 123 parallel to the gravity direction, the rotation unit 13 is loaded with the consistent torque under different rotational angle of the tilt angle.

During the measurement, the object 9 is rotated about the rotation unit 13 and measured by the wavefront measurement unit 11 rapidly by taking the advantages of the rotational symmetrical property of the object 9. Thus, the detecting light measure the symmetrical aberration reflected from the object 9 in rotation. However, if the object 9 is not rotated about its symmetric axis O, the symmetry property breaks. The misalignment induces additional optical aberration reflected from the target surface and may hamper the measurement or reduce measurement precision. To keep such symmetric property holds in the measurement data acquisition, the symmetric axis O of the object has to be collinear with the rotation axis R of rotation unit 13 and the rotation axis R of rotation unit 13 has to be coplanar with the optical axis F of the detecting light.

In this embodiment, in order to make the symmetric axis O collinear with the rotation axis R of the rotation stage, the surface profile measurement apparatus 1 further includes an alignment unit 14 disposed on the rotation unit 13. By placing the object 9 in a holder mechanism at the alignment unit 14, the alignment unit 14 aligns the symmetric axis O to make the symmetric axis O be substantially collinear with the rotation axis R. If the object is a spherical surface, because all the measured points at the surface have the common one center of curvature, we can align the rotation axis R such that the rotation axis R pass through the center of curvature of the object 9 by either tilting or translation of object 9. Therefore, it is preferred that the object alignment unit 14 has a multi-axis alignment adjustment platform, which has the fine adjusting functions in two directional translations (e.g., X and Y directions) perpendicular to the rotation axis R, or two angular tilts (e.g., α and β angular directions) with the rotational axis of the tilt perpendicular to the rotation axis R so as to proceed the alignment procedures with the spherical surface target. However, when the object 9 is an aspheric surface, the aspheric surface does not have a common center point of curvature to all surface points. So, it's impossible to align the symmetric axis O and the rotation axis R to be collinear with only two directional translations or only two angular tilts. As a result, we have to simultaneously perform the fine adjustment of the two directional translations and the two angular tilts.

In this embodiment, in order to make the optical axis F of the wavefront measurement unit 11 be coplanar with the rotation axis R of the rotation unit 13, the surface profile measurement apparatus 1 further includes a measuring light alignment unit 17 disposed on the wavefront measurement unit 11. By aligning the optical axis F of the wavefront measurement unit 11 or the rotation axis R of the rotation stage to coplanar, the misalignment induced optical aberration of the reflected detecting light is minimized during the measurement data acquisition in rotation. Therefore, the measuring light alignment unit 17 preferably has a multi-axis alignment adjustment platform, which has the fine adjusting functions in two directional directions (e.g., X and Y direction) perpendicular to the optical axis F and two angular tilts (e.g., α and β angular directions) perpendicular to the optical axis F so as to proceed the required alignment procedures upon measurement. In this embodiment, as shown in FIG. 1A, the measuring light alignment unit 17 is the mechanism disposed on the reference surface 112 and has the fine adjusting functions in four adjustment directions in total.

The object 9 having a symmetrical axis O0 shows the high symmetrical similarity in rotation about its symmetrical axis O. Therefore, if the symmetrical axis O is collinear with the rotation axis R, then the wavefront measurement unit 11 can measure the fixed substantially similar sub-aperture measurement data at each rotational angle. The fixed measurement data, which does not change with the rotational angle, is determined according to the alignment error between the optical axis F of the detecting light and the rotation axis R, as well as the lens prescription. On the contrary, if the object 9 is not rotated about its symmetrical axis O (i.e., the symmetrical axis O is not collinear with the rotation axis R), then the wavefront measurement unit 11 measures the varying measurement data at different rotational angles. The variation of the measurement data is harmonic with the rotation angle. The harmonic variation is determined by the alignment error between the symmetrical axis O of the object 9 and the rotation axis R as well as the lens prescription. Thus, by measuring the sub-aperture measurement data at different angles and the lens prescription, it is possible to derive the alignment error, which includes the combinations of all possible alignment error combinations between the symmetrical axis O, the optical axis F and the rotation axis R in the space. In other words, the alignment errors include the angular and translational alignment errors between the rotation axis R of the rotation unit 13 and the symmetric axis O, as well as the angular and translational alignment errors between the rotation axis R of the rotation unit 13 and the optical axis F of the wavefront measurement unit 11. Of course, we can selectively derive only one of the alignment errors from the harmonic measurement data.

If the optical aberration induced by the alignment error is too large, the measurement may not be viable at some rotational angles. Thus, in this invention, the object 9 has to proceed the measurement in the condition where the symmetrical axis O is substantially collinear with the rotation axis R and the optical axis F is substantially coplanar with the rotation axis R. More particularly, whenever the object 9 is disposed on the rotation unit 13, it is necessary to align symmetric axis O and rotation axis R to ensure that they are substantially collinear. And the alignment between the optical axis F of the detecting light and the rotation axis R has to be implemented after the reference surface 112 is replaced or the driving unit 12 assembly is installed.

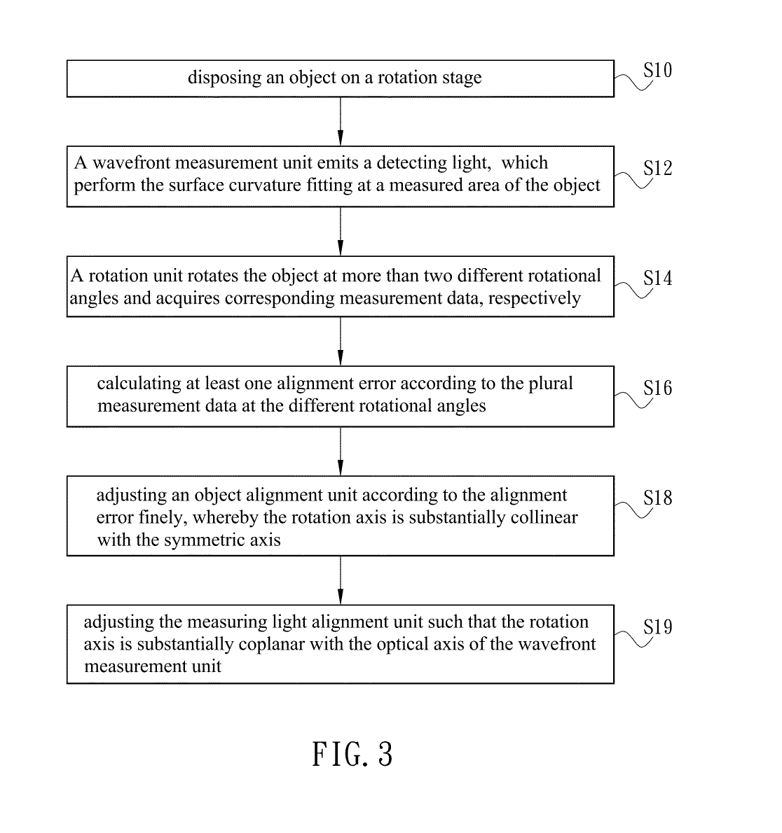

This invention also discloses an alignment method of the surface profile measurement apparatus, which is implemented with the above-mentioned surface profile measurement apparatus. Referring to FIG. 3, the alignment method includes the following steps. In step S10, an object is disposed on a rotation stage. In step S12, the wavefront measurement unit emits a detecting light, which perform the surface curvature fitting at a measured area of the object. In step S14, the rotation unit rotates the object at more than two different rotational angles and acquires the corresponding measurement data, respectively. In step S16, at least one alignment error is calculated according to the plural measurement data at the different rotational angles. In step S18, the object alignment unit is finely adjusted according to the alignment error, whereby the rotation axis is substantially collinear with the symmetric axis.

Here in below, the steps of the alignment method will be described with reference to FIGS. 1A and 3 simultaneously. In the step S10, the object 9 is disposed on the rotation unit 13. In this embodiment, the rotation unit 13 has a holder mechanism, which firmly holds the object 9.

In the step S12, the driving unit 12 drives the object 9 or the wavefront measurement unit 11 to perform the surface curvature fitting between the measured area of the object 9 and the detection light wavefront. The wavefront phase difference at the measured point is preferably smaller than the measurement dynamic range of the wavefront measurement unit 11.

In the step S14, the rotation unit 13 rotates the object 9, and the wavefront measurement unit 11 measures the object 9 at least two different known rotational angles. The measurement data is correlated with the known rotational angles of the rotation axis R wherein the measurement data is acquired.

In the step S16, the plural measurement data acquired at different rotational angles and the surface prescription are used to calculate at least one alignment error. The optimization process of the ray tracing software or the polynomial fitting method, such as the Zernike polynomial, can be used to proceed the derivation of the alignment error of the four-axis or two-axis alignment errors. In which, the plural measured data is simply the optical aberration and it also the part of the merit function of the optimization process while the misalignment error are the variables to be optimized in the optimization process. The alignment error may include relative translational or angular alignment errors on three axes among the symmetric axis O, the rotating axis R and the optical axis F of the wavefront measurement unit 11. In addition, during the surface curvature fitting process, the lens prescription can be obtained by calculating the parameters of the lens according to the travel of motion of the stage of the driving unit 12 and the measurement data.

In the step S18, the object alignment unit 14 is finely adjusted according to the calculated alignment error. It is possible to proceed the automatic or manual adjustment to finely adjust the object alignment unit 14. Next, the steps S12 to S18 can be repeated. If the fringe of the interferogram can be resolved at each rotational angle or the variation of the measurement data with the rotational angle is very small, then the alignment calibration can be accomplished. The object alignment unit 14 in the step S18 may be an automatic or semi-automatic unit. Regarding the automatic unit, a data processing unit 8, such as a computer as shown in FIG. 1A, is coupled to the wavefront measurement unit 11 to proceed the alignment computation, and then the data processing unit 8 controls the object alignment unit 14 to make the rotation axis R be substantially collinear with the symmetric axis O and to make the optical axis F of the detecting light be substantially coplanar with the rotation axis R. Regarding the semi-automatic unit, the data processing unit 8 proceeds the alignment computation, and the user manually adjusts the object alignment unit 14 according to the instructions of the data processing unit 8, so as to make the symmetric axis O be substantially collinear with the rotation axis R.

In addition, the invention may further include a step S19, in which the measuring light alignment unit 17 is adjusted such that the rotation axis is substantially coplanar with the optical axis of the wavefront measurement unit. The step S19 is similar to the step S18 and it proceed the adjustment of the measuring light alignment unit 17 according to the calculated alignment error, and the steps S12 to S19 may also be repeated. If the measurement data is resolved at each rotational angle or the measurement data variance with rotational angle is small, then the alignment calibration can be stopped. The steps S19 and S18 can be simultaneously proceeded, or the steps S18 and S19 can be sequentially proceeded performed without any orders.

It is worth to note that in the alignment process, the symmetric axis O is adjusted in hope to be collinear with the rotation axis R with the best effort. But in practice, due to the mechanical sensitivity limits of the alignment platform, the symmetric axis O may be not exactly collinear with the rotation axis R. Or due to the mild aspherical departure of the tested surface, the alignment may not need a strict alignment result to get the resolvable fringes at all rotational angle. In this case, the symmetric axis O may be regarded as being substantially collinear with the rotation axis R. Similarly, the optical axis F of the wavefront measurement unit 11 is substantially coplanar with the rotation axis R within the permissible error range and the sensitivity limits of the alignment platform.

Referring again to FIG. 1A, after the alignment calibration is proceeded, the rotation unit 13 drives the object 9 to rotate about the rotation axis R, which is collinear with the symmetric axis O, and the image sensor 113 simultaneously exposures and acquire the measurement data of the object 9 at different measured points in a radial ring, then correlates the measurement data to the rotational angle of rotation axis R at which the measurement data is acquired. Thus, after the rotation unit rotates the object 9 for multiple rounds, we can sort the measurement data such that all the measured points of the measured area will have a plurality of measurements acquired in different rotational rounds. In theory, if the wavefront measurement unit 11 is an interferometer, the plurality of measurement data of the object 9 will be identical. However, when the rotation unit 13 rotates, inevitably the rotation unit 13 generates the mechanical vibrations, which cause the reference surface 112 of the wavefront measurement unit 11 or the object 9 to generate the random interference phase shifting. If the direction of vibration displacement is parallel to the optical axis F of the wavefront measurement unit 11, then the wavefront phase generates the random piston like phase shifting. On the contrary, if the direction of vibration displacement is perpendicular to the optical axis F of the wavefront measurement unit 11, then the random tilt type phase shifting is generated. After multiple times of rotation rounds, the plural interferogram with the random phase shifting, at the same rotational angle can be rearranged and recombined. The calculation of the interference phase of these interferograms then can be proceeded to obtain the surface deformation of the object 9 without being affected by the random mechanical vibrations by the method disclosed by Lin et. al. (P. C. Lin, Y. C. Chen, C. M. Lee, and C. W. Liang, “An iterative tilt-immune phase-shifting algorithm,” Optical Fabrication and Testing, OSA Technical Digest, paper OMA6, Jackson Hole, Wyo., Jun. 13-17, 2010).

Of course, in practice, if the wavefront measurement unit 11, the driving unit 12 or the rotation unit 13 is very stable and the random mechanical vibrations are too small, then the surface profile measurement apparatus 1 may further include an interference phase shifter coupled to the rotation unit 13, the driving unit 12 or the wavefront measurement unit 11. While the object 9 is rotating, the phase shifter generates a plurality of interferograms with the random or predictable interference phase shifts interval at the same measured point. And the interference phase at the same measured point can be obtained.

In addition, to ensure the acquired measurement data is correlated with the correct rotational position at which the measurement data is acquired, the surface profile measurement apparatus 1 of this embodiment may further include a rotational position measurement device 15 detecting the rotational angle of the rotation axis R and is electrically connected to the wavefront measurement unit 11. When the wavefront measurement unit 11 acquires the interferogram, the wavefront measurement unit 11 correlates the rotational angle of the rotation axis R with the measurement data. Thus, we can obtain the correct rotational location of the measured area of the object 9. The rotational position measurement device 15 is, for example, a stepping motor pulse counter, which calculates the rotating angle of the rotation axis R driven by the counting the pulse steps in the stepping motor. Of course, in practice, the rotational position measurement device 15 may also be an encoder or and other application software as long as it can verify and obtain the rotating angle of the rotation axis R while each interferogram is acquired. However, the invention is not particularly restricted thereto.

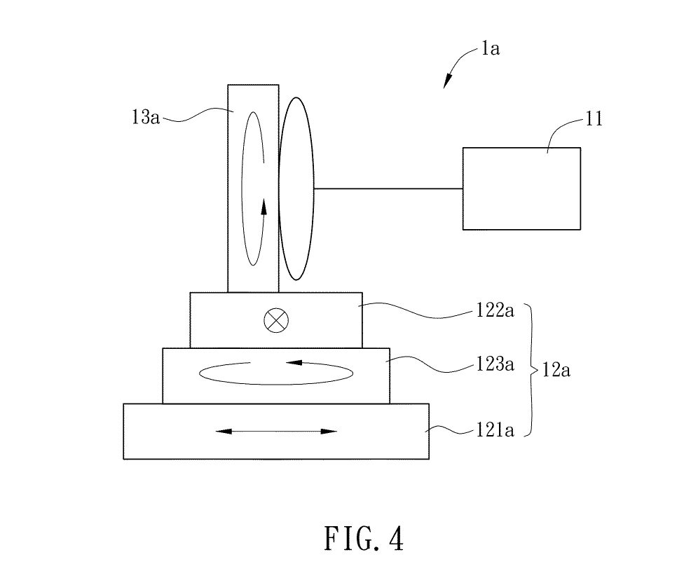

Next, a plurality of mechanism modifications of the surface profile measurement apparatus will be described. FIG. 4 is a schematic illustration showing the second preferred embodiment of the invention of the surface profile measurement apparatus 1c. As shown in FIG. 4, the differences between the surface profile measurement apparatus 1a and the surface profile measurement apparatus 1 reside in that the locations of the tilting stage 123 and the defocusing stage 121 are exchanged, the tilting stage 123a of the surface profile measurement apparatus 1a is disposed on the defocusing stage 121a, the decentering stage 122a is disposed on the tilting stage 123a, and the rotation stage 13a is disposed on the decentering stage 122a.

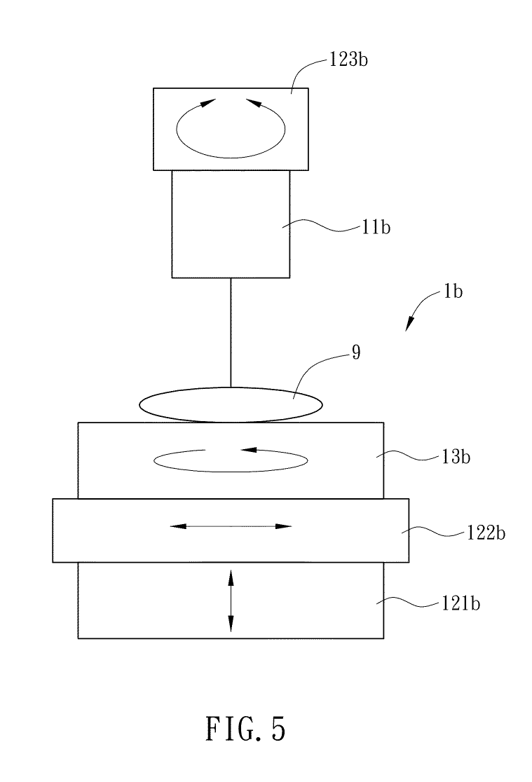

FIG. 5 is a schematic illustration showing the third preferred embodiment of the invention of the surface profile measurement apparatus 1c. As shown in FIG. 5, the differences between the surface profile measurement apparatus 1b and the surface profile measurement apparatus 1 reside in that the decentering stage 122b of the surface profile measurement apparatus 1b is disposed on the defocusing stage 121b, wherein the decentering stage 122b is driven in a horizontal plane and the defocusing stage 121b is driven in the direction perpendicular to decentering motion and in the same horizontal plane as decentering motion. The rotation unit 13b holds the object 9 and is disposed on the decentering stage 122b, wherein the rotation unit 13b rotates at the horizontal plane in this embodiment; and the wavefront measurement unit 11b is disposed on the tilting stage 123b, wherein the tilting stage 123b rotates in the horizontal plane in this embodiment.

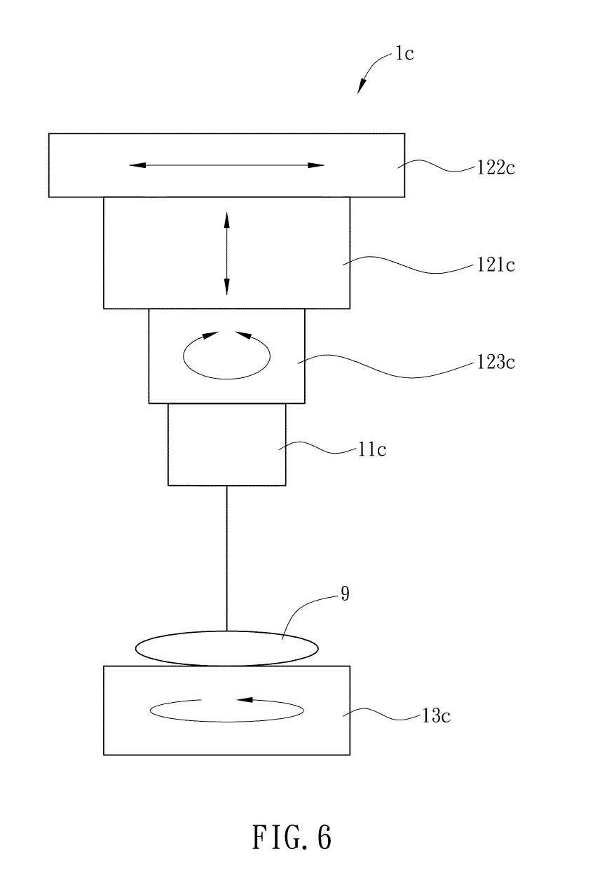

FIG. 6 is a schematic illustration showing fourth preferred embodiment of the invention of the surface profile measurement apparatus 1c. As shown in FIG. 6, the differences between the surface profile measurement apparatus 1c and the surface profile measurement apparatus 1 reside in that the tilting stage 123c is coupled to the wavefront measurement unit 11c, wherein the tilting stage 123c is driven in a horizontal angular direction in this embodiment; that the defocusing stage 121c is disposed on the tilting stage 123c, wherein the defocusing stage 121c is driven in a vertical direction in this embodiment; and that the decentering stage 122c is disposed on the defocusing stage 121c, wherein the decentering stage 122c is driven in the horizontal direction in this embodiment.

After completing the alignment procedure and ensuring that the fringes of the interferogram are not too dense to be measured at all the rotational angles, the acquisition can be proceeded. The sub-aperture interference phase acquisition method can be used to acquire the overlapped sub-aperture interference fringe data covering all the surfaces of the object 9 and stitched to a complete object surface profile. However, the aspherical departure of the tested lens has to be mild in the sub-aperture stitching method. Although the aspherical departure is increased by using the additional null optics, the additional null optics required by this method has to be manufactured and positioned precisely to ensure measurement accuracy, thereby increasing the overall measurement cost.

In order to obtain the full aperture surface profile with increased aspherical departure measurement range, the invention provides a novel improved sub-aperture measurement data acquisition method, in which more than two directional surface curvature fitting processes are proceeded at the same measured point of the object 9. Wherein the directional curvature fitting process, in contrast to the said curvature fitting process, fits the curvature of wavefront of detecting light to the measured area of object 9 in certain direction instead of the whole sub-aperture circular area such that the fringe density is the most coarse in this said direction within the sub-aperture. Thus, it is possible to have non-resolvable fringe in the sub-aperture area other than the said direction and the effective measurement data acquisition area within the sub-aperture is reduced. The first directional surface curvature fitting process acquires a plurality of first measurement data in the first elongated axis direction in the sub-aperture, and the second surface directional curvature fitting process acquires the secondary measurement data with second elongated axis direction in the sub-aperture. The first measurement data and the secondary measurement data are then stitched to form the full aperture data. By using improved sub-aperture measurement data acquisition method, the circular measured area within a sub-aperture is reduced to the strip-like measured area with an elongated axis, thereby effectively decrease the wavefront phase difference of the detecting light and increase the aspherical departure measurement range of the said method.

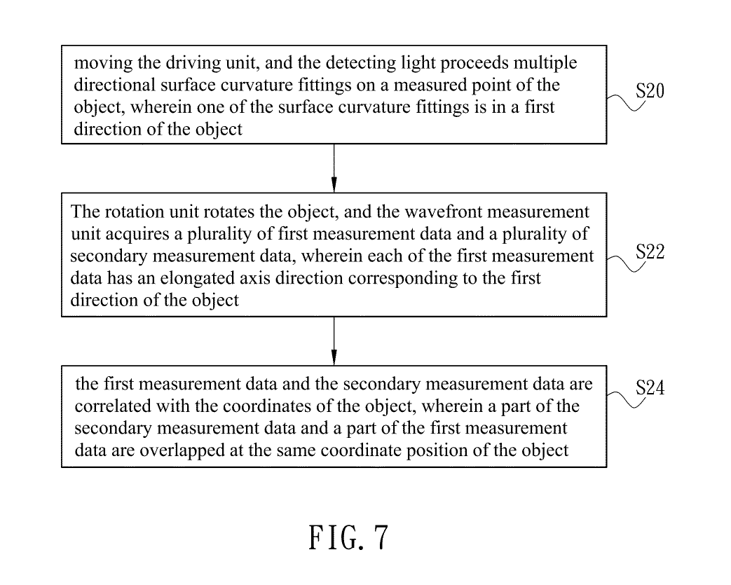

FIG. 7 is a flow chart showing an improved sub-aperture measurement data acquisition method of the invention, which is performed but not limited to the mentioned surface profile measurement apparatus 1 and includes the following steps. In step S20, the driving unit is moved, and the detecting light proceeds multiple directional surface curvature fittings on a measured point of the object, wherein one of the surface curvature fittings is in a first direction of the object. Correspondingly, the resolvable fringe measured data within the sub-aperture image is also in the said first direction of the object. In step S22, the rotation unit rotates the object 9, and the wavefront measurement unit acquires a plurality of first measurement data and a plurality of secondary measurement data, wherein each of the first measurement data has an elongated axis direction corresponding to the first direction of the object. In step S24, the first measurement data and the secondary measurement data are correlated with the coordinates of the object, wherein a part of the secondary measurement data and a part of the first measurement data are overlapped at the same coordinate position of the object. It's worth to note that the step S20, S22 and S24 has no fixed sequence order. That means, the directional surface curvature fitting in step S20 can be performed after a plurality of measurement data is taken in step S22 or the coordinate correlation S24 can be predetermined before performing any direction surface curvature fitting processes in S22.

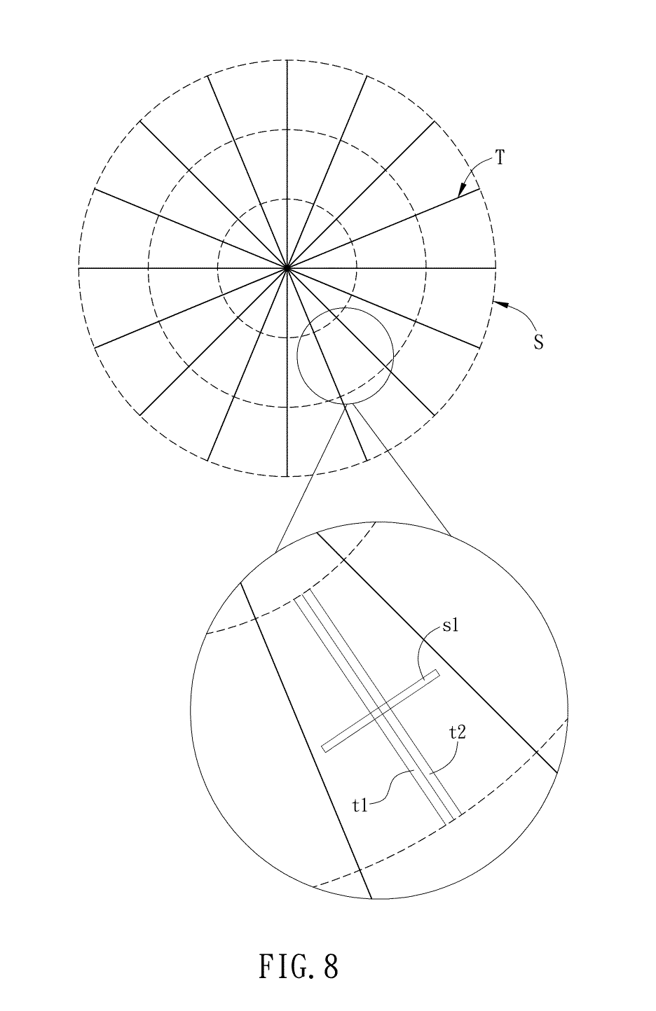

In the step S20, unlike the prior art sub-aperture measurement method, which acquires all the measured points with resolvable fringes within the sub-aperture, the invention acquires the strip-like measured area with resolvable fringes within the sub-aperture. This strip-like measured area in the sub-aperture has a certain elongated axis direction. This type of surface curvature fitting in a certain direction of sub-aperture of the object 9 is referred as the directional surface curvature fitting. The measurement data acquisition method of the invention can be implemented with but not limited to the driving unit 12 of the mentioned surface profile measurement apparatus, whereby the defocusing motion, the decentering motion and the tilting motion are proceeded through the motion of the driving unit 12. So that the detecting light emitted from the wavefront measurement unit 11 is partially reflected by the surface of the object 9 back to the wavefront measurement unit 11. Thus, the directional surface curvature fitting is performed of the detecting light of the wavefront measurement unit 11 and a certain direction of the measured surface of the object 9. These direction, for example, could be the tangential direction T, the sagittal direction S or the directions other than tangential direction T and sagittal direction S of the object 9 as shown in FIG. 8.

Please refer to FIGS. 2A, 2B and 8 simultaneously. In FIG. 2A, the tangential direction T is in the plane defined by the optical axis F of the wavefront measurement unit 11 and symmetric axis O of the object 9 and tangential direction T is perpendicular to the optical axis F of the wavefront measurement unit 11. The sagittal direction S is perpendicular to both the tangential direction T and the optical axis F, thus, sagittal direction S is in the direction out of the plane. FIG. 8 is a schematic top view of the object 9 showing the corresponding tangential direction T and sagittal direction at the object 9. When the wavefront measurement unit 11 obtains a measurement data in tangential direction T at object 9, the curvature of the wavefront of the detecting light is substantially the best fitted surface curvature of the measured surface object 9 in the tangential direction T. Similarly, when the wavefront measurement unit 11 obtains a measurement data of the object in the sagittal direction S, the curvature of the incident wavefront of the detecting light is substantially the best fitted surface curvature of the measured surface of the object 9 in the sagittal direction S.

In the step S22, the object is rotated by the rotation unit 13 about its symmetric axis O, and the wavefront measurement unit 11 simultaneously acquires the measurement data located at different rotational angle of surface of the tested object 9. Since only a portion of sub-aperture, the said enlonged measured area, has the resolvable fringe to be measured, the area of the acquired measurement data is limited to where the measured area has resolvable fringe. However, since the object 9 is being rotated about its symmetric axis and being measured simultaneously, all the surface measurement data located at the same radial position of the object 9 can be acquired even the enlonged measured area within the sub-aperture is as narrow as a thin line. When the aspherical surface of object 9 has steep aspherical departure, the width of the measured area within the sub-aperture is narrow because the radii of curvature of all the surfaces of the aspheric lens are not the same. However, if the object 9 surface is a spherical surface or a mild aspherical surface, all the measured points within the sub-aperture can be measured in a single exposure of the camera sensor. But one can still acquire only a line or a portion of data within the measured area to complete the acquisition of the whole surface located at the same radial position of the object 9 at the cost of increasing rotational resolution of the rotation unit 13. Thus, in the invention, the acquired measurement data area is not limited to the whole resolvable fringe measured area within the sub-aperture, and it can be a line of pixels of measured points or a two dimensional enlonged measured area within the sub-aperture.

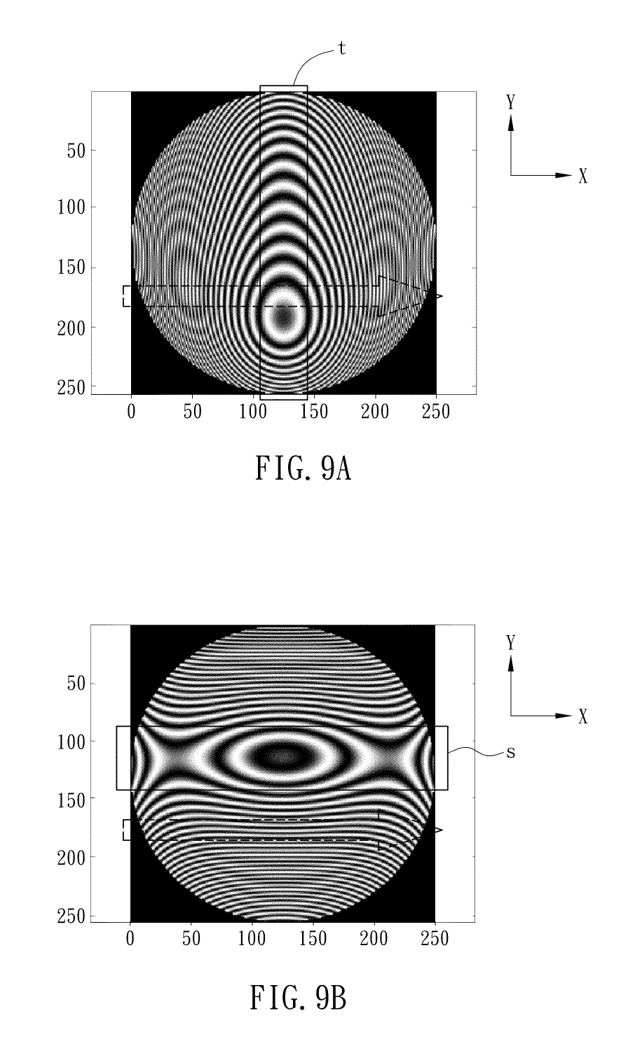

Please refer to FIGS. 2A, and 8 to 9B simultaneously. FIGS. 9A and 9B are interferograms when the aspheric object is being measured in the tangential direction T and the sagittal direction S, respectively. The Y axis in the sub-aperture image corresponds to the tangential direction T and the X axis in the sub-aperture image corresponds to the sagittal direction S. In a preferred embodiment, wavefront measurement unit 11 acquires resolvable fringe measurement data in one dimensional line region by simultaneous rotating and acquisition exposure. Wherein a said first direction of the measurement data can be the Y direction in the sub-aperture image of the wavefront measurement unit 11 which corresponds to the first direction, also the tangential direction T, at the object. In the measurement, the object 9 is simultaneously rotated and acquired a plurality of enlonged measurement data t1 and t2 in the tangential direction T at the different rotational positions. Wherein the Y direction is also perpendicular to the sagittal direction S indicated by the dashed line arrow of the object 9.

After the rotation of several rounds, a plurality of one-dimensional tangential directions T of the enlonged measurement data t (only t1 and t2 are depicted in the example of FIG. 8) may be obtained at each measured point of the object 9. Thus, the all the surface measured points located in the same radial ring of the object 9 can be acquired, wherein the complete object 9 surface is divided into three radial rings as indicated by the dashed lines in the example of FIG. 8. However, the one-dimensional, tangential direction T measurement data t1 t2 lacks the lateral data confinement required for measurement data stitching in the perpendicular direction. Thus, there has to be at least an X-direction measurement data s1 shown in FIG. 9B acquired to proceed the stitching of the tangential direction measurement data in the perpendicular direction. As a result, the secondary directional surface curvature fitting is required to acquire the secondary measurement data in the sagittal direction S. With the secondary measurement data, the tangential direction T measurement data t1 and t2 is then possibly be stitched into a two-dimensional ring data in the direction parallel to the elongated axis of the secondary measurement data. As a result, the driving unit 12 has to be performed again the directional surface curvature fitting in the sagittal direction S of the object by movement combinations of defocusing, decentering, and tilt depends on the prescription of the lens and the predetermined directional surface curvature fitting direction. To gain higher data redundancy for later measurement data stitching, a third time or more directional surface curvature fitting can be proceeded to acquire the measurement data in directions other than tangential or sagittal directions.

Referring again to FIGS. 9A and 9B, the measurement data t is the acquired measured surface of the object in the tangential direction T. The measurement data t has a first elongated axis Y direction and the measurement data area outside the measurement data t cannot be acquired due to the over dense interference fringes. By deleting the measured area with over dense interference fringe from phase calculation and phase stitching, the interference phase calculation time can be shortened and also the phase stitching errors reduce.

It worth to note that the multi-step phase shifting measurement can be used to calculate the interference phase at each measured point at the cost of increasing acquisition time by stopping the rotation at each measured sub-aperture position. Or, one can use the simultaneous rotation and acquisition method to acquire the vibration modulated interferogram and calculate the interference phase.

Finally, in the step S24, the first measurement data and at least one secondary measurement data are correlated with the coordinates of the object 9. When project the first measurement data and secondary measurement data into the coordinate of object 9, a part of the secondary measurement data and the part of the first measurement data are overlapped in the coordinate of object 9. The measurement data acquisition of the surface profile of the object 9 is completed after correlation between the measurement data and object 9 coordinate.

Referring again to FIG. 7, the acquisition method of this embodiment may further include the steps of adding a calibration data of the wavefront measurement unit (e.g., the intrinsic error the wavefront measurement unit itself) to calibrate a wavefront error or the coordinate distortion error generated from the wavefront measurement unit; and correlating the calibrated first measurement data and the secondary measurement data with the coordinates of the object.

In summary, the surface profile measurement apparatus, the alignment method thereof and the improved sub-aperture measurement data acquisition method of the invention have the features that are insensitive to the random mechanical vibrations and dynamic acquisition during rotation, so that the precision of the measurement results can be improved, and the time for the measurement can also be shortened.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A surface profile measurement apparatus, which measures a surface profile of an object, comprising:
a wavefront measurement unit, which has an image sensor and emits a detecting light;
a driving unit, which has a plurality of motion stages for moving the object or the wavefront measurement unit to proceed the surface curvature fitting; and
a rotation unit, which has a rotary axis and is disposed on one of the stages of the driving unit, wherein the rotation unit holds the object, and when measuring the object, the rotation unit rotates the object and the image sensor simultaneously exposes and acquires a measurement data formed by the detecting light from the object.

2. The measurement apparatus of claim 1, wherein the stages have a defocusing motion, a decentering motion and a tilting motion to proceed a surface curvature fitting process.

3. The measurement apparatus of claim 2, wherein the stages providing the tilting motion have a rotation axis, and the rotation axis is substantially parallel to the gravity direction.

4. The measurement apparatus of claim 1, wherein the object has a symmetrical axis, the wavefront measurement unit has an optical axis, and when measuring the object, the rotary axis is substantially collinear with the symmetrical axis and is substantially coplanar with the optical axis.

5. The measurement apparatus of claim 1, further comprising:
a rotational position measurement device, which is electrically connected to the wavefront measurement unit and acquires a rotational angle of the rotary axis,
wherein, when the wavefront measurement unit captures the measurement data, the wavefront measurement unit acquires the rotational angle of the rotary axis and correlates with the measurement data.

6. The measurement apparatus of claim 1, wherein the wavefront measurement unit is an interferometer, and when the rotation unit rotates the object, the wavefront measurement unit acquires the plural measurement data with different interference phase changes of the same measured points of the object.

7. The measurement apparatus of claim 6, wherein the plural measurement data with the different interference phase changes are induced from random mechanical vibrations generated from the motions of the wavefront measurement unit, the driving unit or the rotation unit.

8. The measurement apparatus of claim 6, further comprising:
an interference phase shifter, which is coupled to the rotation unit, the driving unit or the wavefront measurement unit, and when the object rotates, the interference phase shifter simultaneously phase shifts the plural measurement data with random or predictable interference phase changing.

9. An alignment method of a surface profile measurement apparatus, which is implemented with a surface profile measurement apparatus for measuring a surface profile of an object, the surface profile measurement apparatus comprising a wavefront measurement unit, a driving unit, a rotation unit and an object alignment unit, the rotation unit having a rotary axis, the object having a symmetric axis, and the wavefront measurement unit having an optical axis, the alignment method comprising:
disposing the object on the rotation unit;
the wavefront measurement unit emitting a detecting light, which proceeds a surface curvature fitting on a measured area of the object surface;
the rotation unit rotating the object to at least two different rotational angles and acquiring corresponding measurement data at the different rotational angles;
calculating an alignment error according to the measurement data acquired at different rotational angles; and
adjusting the object alignment unit according to the alignment error, whereby the rotary axis and the object axis are substantially collinear.

10. The alignment method of claim 9, wherein the object alignment unit has a multi-axis alignment adjustment platform for moving the object in two translational or two angular directions.

11. The alignment method of claim 9, wherein the surface profile measurement apparatus further comprises a measuring light alignment unit, which has a multi-axis alignment adjustment platform for moving the object in two translational or two angular directions, the alignment method further comprising:
moving the measuring light alignment unit, whereby the rotary axis and the optical axis of the wavefront measurement unit are coplanar substantially.

12. The alignment method of claim 9, wherein the alignment error is derived by a lens prescription of the object or travels of motions of the driving unit.

13. The alignment method of claim 9, wherein the alignment error comprises an angular or translational alignment error between the rotary axis of the rotation unit and the symmetric axis of the object.

14. The alignment method of claim 9, wherein the alignment error comprises an angular or translational alignment error between the rotary axis of the rotation unit and the optical axis of the wavefront measurement unit.

15. An improved sub-aperture measurement data acquisition method, which is implemented with a surface profile measurement apparatus comprising a driving unit, a rotation unit and a wavefront measurement unit, the data acquisition method comprising:
moving the driving unit and a measuring light emitted by the wavefront measurement unit proceeding multiple surface curvature fittings to the same measured area of an object, wherein one of the surface curvature fittings is along a first direction of the object;
rotating the rotation unit and the wavefront measurement unit acquiring a plurality of first measurement data and a plurality of secondary measurement data, wherein the acquired first measurement data have an elongated axis direction corresponding to the first direction of the object; and
correlating the first measurement data and the secondary measurement data with the coordinates of the object, wherein a part of the first measurement data and a part of the secondary measurement data are overlapped at the same coordinate position.

16. The data acquisition method of claim 15, further comprising:
adding a calibration data of the wavefront measurement unit to calibrate a wavefront error or a coordinate error induced from the wavefront measurement unit; and
correlating the calibrated first measurement data and the secondary measurement data with the coordinates of the object.

17. The data acquisition method of claim 15, wherein the elongated axis direction of the first measurement data correspondingly is the tangential direction of the object.

18. The data acquisition method of claim 15, wherein when the wavefront measurement unit obtains the first measurement data in a tangential direction of the object, the radius of curvature of the incident measuring light wavefront upon the measured area substantially equals the best fitted radius of curvature along the tangential direction of the measured area of the object.

19. The data acquisition method of claim 15, wherein the secondary measurement data has another elongated axis direction, which corresponds to a second direction of the object, and the first direction and the second direction are different.

20. The data acquisition method of claim 15, wherein when the wavefront measurement unit obtains the secondary measurement data with elongated axis in a sagittal direction of the object, the radius of curvature of the incident measuring light wavefront upon the measured area substantially equals the best fitted radius of curvature along the sagittal direction of the measured area of the object.
